(19) United States
(12) Patent Application Publication
(10) Pub. No.: US 2018/0339640 A1
(43) Pub. Date: Nov. 29, 2018

(54) VEHICLE TRAILER WITH ENHANCED STABILITY

(71) Applicant: ShuttleHawk Productions LLC, Delray Beach, FL (US)

(72) Inventors: Ed Shuttleworth, Green Cove Springs, FL (US); Douglas Hawk, Delray Beach, FL (US)

(21) Appl. No.: 15/605,280

(22) Filed: May 25, 2017

(51) Int. Cl. B60P 7/08; B62D 7/22

(52) U.S. Cl. CPC B60P 7/0815; B62D 12/02; B62D 7/22

(57) ABSTRACT

One embodiment of a trailer of the present invention includes a longitudinal member with a coupling assembly secured to the longitudinal member at one end and wheels secured to the longitudinal member at another end. The coupling assembly includes a first portion connectable to a vehicle so that when connected, the first portion is rotatable relative to the vehicle about a first axis that is approximately perpendicular to a ground surface below the vehicle. The coupling assembly further includes a second portion connected to the first portion and the longitudinal member. The second portion is rotatable relative to the first portion about a second axis. The second portion is further configured so that the longitudinal member is rotatable relative to the second portion of the coupling assembly about a third axis.

### BACKGROUND OF THE INVENTION

Watersports are a popular activity enjoyed by many people. However, because travel is often required to get to a location where watersports can be undertaken, challenges often arise in reaching such locations, whether they are beaches or other types of shoreline. One major obstacle is the need to use a car to pull equipment, and the heavy traffic often encountered on the road while traveling by car. Another difficulty is carrying equipment without the use of a car. To address these challenges, trailers have been developed for use with bicycles, which may be operated without being held up by traffic.

To improve maneuverability of bicycle trailers carrying equipment, existing designs have included simple structural features that allow some movement of the trailer relative to a bicycle pulling it. However, existing designs do not account for the many operational conditions of a bicycle including its various positions relative to the ground during use, causing the trailer to lack stability. Moreover, existing trailers are often unstable when loaded without being held by an operator or otherwise secured to a bicycle. Without further improvement, existing trailers are inadequate to prevent damage to equipment loaded onto such trailers, particularly damage due to equipment tipping over.

Thus, a need exists for a trailer that can solve the above challenges with improved versatility and an ability to carry equipment in a safe and secure manner. A need also exists for a trailer that can provide customized support so that a variety of equipment shapes and sizes can be carried by the trailer.

### BRIEF SUMMARY OF THE INVENTION

In one aspect, the present invention relates to a trailer adapted for securement to a vehicle and further adapted to carry equipment such as watersports equipment. The trailer includes three axes of rotation near an end securable to the vehicle so that the trailer remains stable no matter the movement or orientation of the vehicle. Stability is obtained in part because a frame and wheels of the trailer remain in a generally uniform orientation relative to the ground below the trailer at all times. The trailer also includes versatile support bars for direct bearing of load from equipment placed thereon. The support bars are easily adapted to be positioned at different locations and positions on the trailer to suit particular types of equipment and uses for such equipment.

In operation, the trailer is configured so that when the vehicle tilts to one side or another, the angle of the vehicle frame relative to the ground changes independently of an angle of the trailer relative to the ground. In this manner, the trailer is advantageous in that the equipment carried by the trailer does not tip over while being pulled by the vehicle. Similarly, when the trailer is in an at rest position prior to securing it to the vehicle, equipment can be loaded onto the trailer without risk of damaging the equipment as the trailer remains stable, particularly because a longitudinal member of the trailer has a fixed structure and the connection location between the longitudinal member and a U-shaped member near the wheels is also fixed.

In another embodiment, the present invention relates to a trailer that includes a longitudinal member with first and second ends, wheels connected to the second end of the longitudinal member and a coupling assembly. The coupling assembly includes a rear end and a forward end, the rear end connected to the first end of the longitudinal member and the forward end adapted to be connected to a vehicle. In addition, the coupling assembly is structured so that when it is connected to a vehicle, the longitudinal member is rotatable relative to the vehicle about three separate axes.

In a variant, the coupling assembly includes a first portion, the first portion also including the forward end. The first portion is rotatable relative to the vehicle about a first axis when connected to the vehicle and it is approximately perpendicular to a ground surface below the vehicle when connected to it. In this variant, the coupling assembly further includes a second portion also including the rear end. The second portion is rotatable relative to the first portion about a second axis. The second portion is structured so that the longitudinal member is rotatable relative to the second portion of the coupling assembly about a third axis. In a further variant, the second axis is approximately perpendicular to the first axis. In another variant, the third axis is approximately perpendicular to the second axis. In yet another variant, the third axis passes through the first axis, the second axis and a connection point between the first portion of the coupling assembly and a frame member of the vehicle.

In another variant, the second portion of the coupling assembly includes a first pin extending outward from a body of the second portion. The first pin is adapted to extend into an opening in the longitudinal member and to maintain securement between the second portion and the longitudinal member. In a variant, the trailer also includes a second pin connected to the first pin. The second pin abuts an interior structure within the longitudinal member. In particular, the second pin prevents separation of the second portion of the coupling assembly from the longitudinal member when the coupling assembly and the longitudinal member are subject to forces directed away from an interface between the coupling assembly and the longitudinal member. In yet another variant, the first portion of the coupling assembly includes an opening therethrough sized to fit over a frame member of the vehicle. In yet another variant, the second portion of the coupling assembly includes an opening therethrough in communication with a second opening through the first portion when the second and first portion are connected to one another. The opening is sized and positioned for the placement of a third pin therethrough, the third pin being positioned through the second axis of rotation.

In another variant, the trailer also includes an extension member connecting the longitudinal member to the wheels. The extension member is fixed to the longitudinal member at a proximal end and fixed to an axle of the wheels at a distal end. In yet another variant, the longitudinal member is made of aluminum.

In one embodiment, a trailer includes a longitudinal member with a length extending between a first end and a second end, wheels connected to the second end of the longitudinal member, and a coupling assembly. The coupling assembly is connected to the first end of the longitudinal member and adapted for connection to a vehicle. The coupling assembly includes structure so that when it is connected to the vehicle, an angle between a wheel of the vehicle, which defines a first plane, and a ground surface below the vehicle, which defines a second plane, varies independently from an angle between one of the wheels of the trailer, which define a third plane, and the second plane. The longitudinal member is made of metal material and is fixed about its longitudinal axis. In this manner, the first end, second end and locations in between do not rotate with respect to one another about a longitudinal axis of the longitudinal member. In addition, the wheels of the trailer are connected to the longitudinal member such that the longitudinal member is rotationally fixed relative to an axle through the wheels of the trailer about a longitudinal axis of the longitudinal member.

In a variant, the trailer is structured so that when the trailer is secured to the vehicle, the longitudinal member is adapted to move about three axes relative to a frame member of the vehicle without contacting the vehicle. In another variant, the length of the longitudinal member is telescopically adjustable by advancing a first or second portion of the longitudinal member relative to a second portion of the longitudinal member. In yet another variant, the trailer also includes a U-shaped extension member fixedly secured to the second end of the longitudinal member and fixedly secured to the axis through the wheels of the trailer. The aforementioned securement of the U-shaped extension member is such that it is positioned in between the longitudinal member and the axle for the wheels of the trailer.

In yet another embodiment, a trailer includes wheels, a longitudinal member, and a storage support member. The longitudinal member includes a first end and a second end, the first end adapted to be connected to a vehicle and the second end connected to the wheels. The storage support member is removably attachable to the longitudinal member. In particular, the storage support member is removably attachable at any position about an axis through a length of the longitudinal member. The storage support member is also removably attachable at any position along a length of the longitudinal member.

In a variant, the trailer also includes a second and a third storage support member. A combination of these storage support members and the first storage support member, when attached to the longitudinal member, are adapted to support up to 200 pounds of weight when such weight is distributed uniformly over all three members. In a variant, the storage support member also includes a clamp removably attached to the longitudinal member and a lateral bar. The clamp includes a lower support sized to receive the longitudinal member therein and a dual flange support positionable around the lower support and over the longitudinal member. The dual flange support includes openings for the placement of fasteners therethrough to secure the lateral bar to the clamp.

In another variant, the trailer includes a second storage support member removably attached to the longitudinal member such that the second storage support member is attachable at a different position about the axis of the longitudinal member than the storage support member. In yet another variant, a second storage support member is removably attached at any location on the longitudinal member from the first to second end.

### BRIEF DESCRIPTION OF THE DRAWINGS

FIG. 1 illustrates a perspective view of one embodiment of the trailer.

FIG. 2 illustrates another perspective view of the embodiment of FIG. 1.

FIG. 3 illustrates a close up perspective view of a coupling assembly of the trailer of FIG. 1.

FIG. 4A illustrates a top view of the coupling assembly of the trailer of FIG. 1.

FIG. 4B illustrates a side view of the coupling assembly of the trailer of FIG. 1.

FIG. 4C illustrates a side view of components of the coupling assembly of the trailer of FIG. 1.

FIG. 5 illustrates a close up perspective view of a storage support member and a rear axle of the trailer shown in FIG. 1.

FIG. 6A illustrates a side view of the storage support member of the trailer shown in FIG. 1.

FIG. 6B illustrates another side view of the storage support member of the trailer shown in FIG. 1.

### DETAILED DESCRIPTION

The present invention relates to apparatuses, methods of assembly and methods of use of a trailer. One purpose of the trailer is to aid in transporting equipment from one location to another. The trailer can also be used to store equipment. The trailer is structured for simple securement to a vehicle such as a bicycle and for safe, efficient and non-turbulent travel over roadways, paths and trails when pulled by the vehicle.

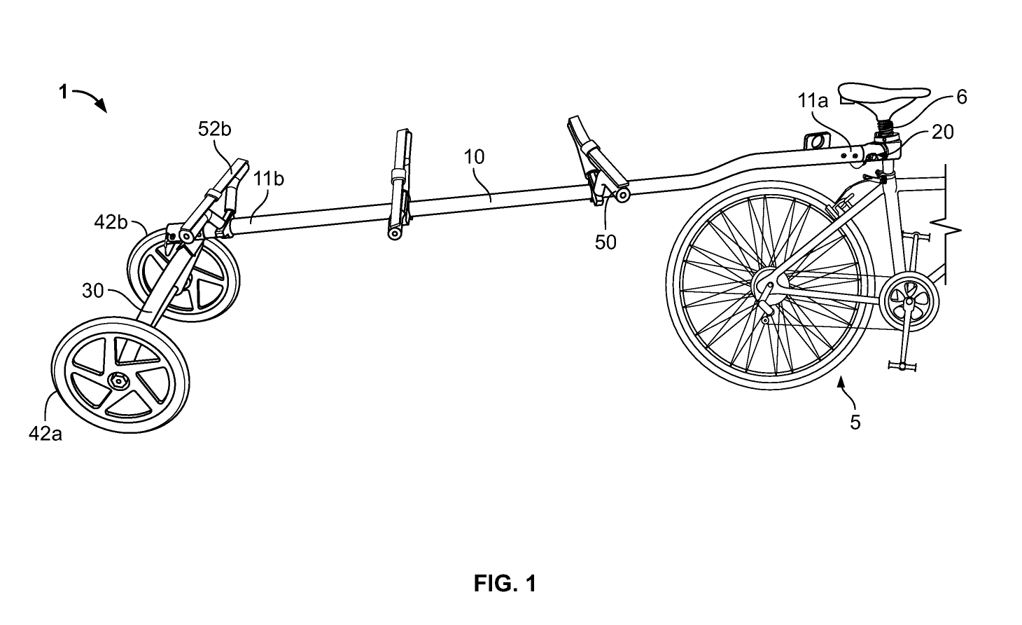

A first aspect of the present invention relates to a vehicle trailer 1, one embodiment of which is shown in FIG. 1. Trailer 1 as shown has several components including a longitudinal member 10, a coupling assembly 20, a U-shaped bar 30 and a rear axle 40 with two wheels 42a, 42b. Disposed on longitudinal member 10 are three storage support members 50. As depicted, trailer 1 is attached to a vehicle 5.

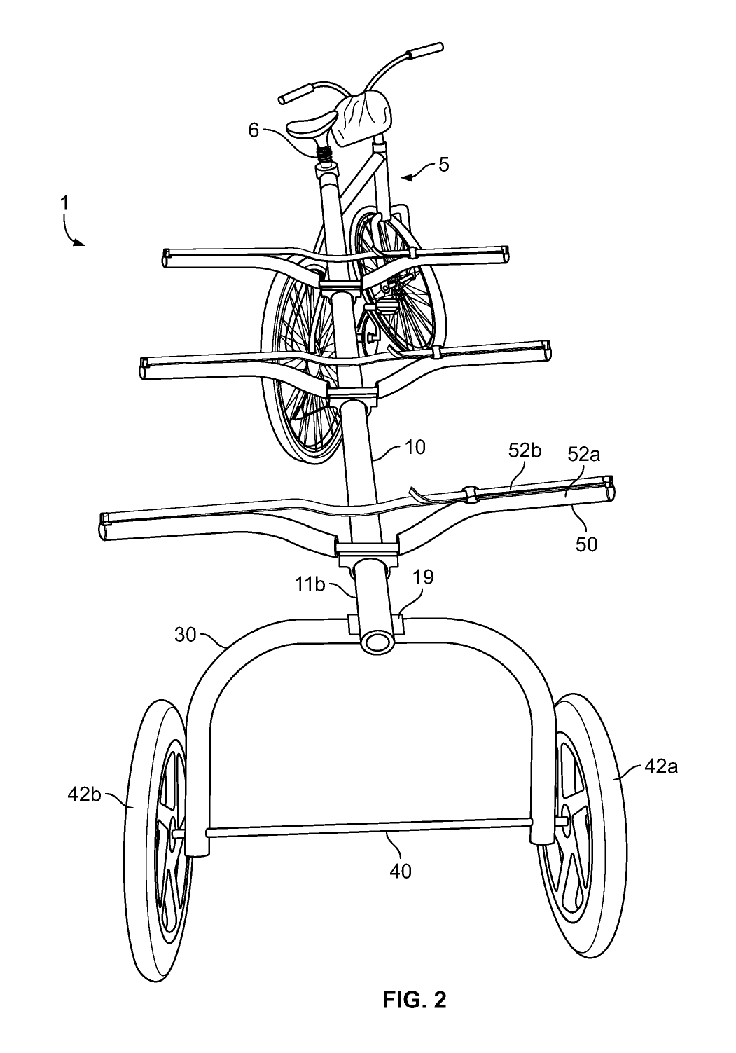

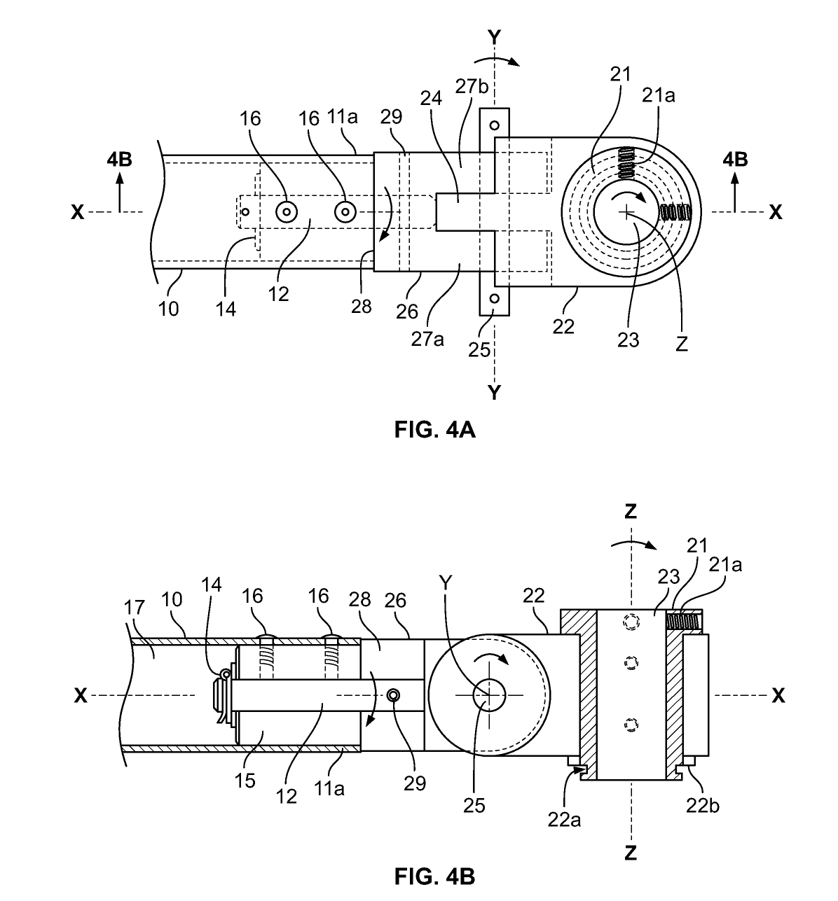

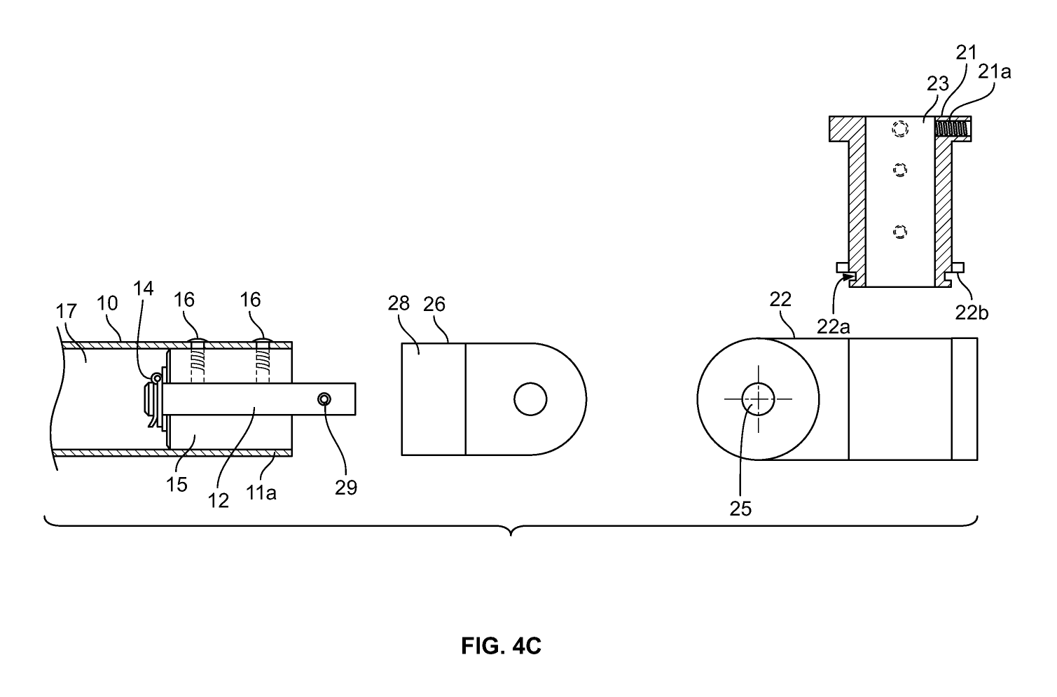

Longitudinal member 10 has a tubular shape and extends over a length spanning a majority of the trailer 1. Having a tubular shape, longitudinal member 10 is hollow. Nonetheless, the sectional shape of the longitudinal member 10 is not limited to that shown in FIGS. 1 and 2. An alignment of the longitudinal member 10 along its length varies so that when secured to vehicle 5, as described below, there is room for structure of the vehicle, such as a wheel of a bicycle. Longitudinal member 10 is of a length sufficient to carry watersports equipment, such as a surfboard, standup paddleboard, etc. and is preferably made of anodized aluminum. Use of aluminum material is advantageous in that it is lightweight making it practical for use among a large portion of the general population. A first end 11a of longitudinal member is configured to be secured to coupling assembly 20. At first end 11a designed to abut coupling assembly 20, a solid structure 15 is disposed inside hollow area 17 of longitudinal member 10. Solid structure 15 itself includes a passage sized to accommodate a pin 12, as depicted in FIGS. 4A and 4B. Solid structure 15 is secured within longitudinal member 10 by screws 16, although other means of securement as known in the art may also be used.

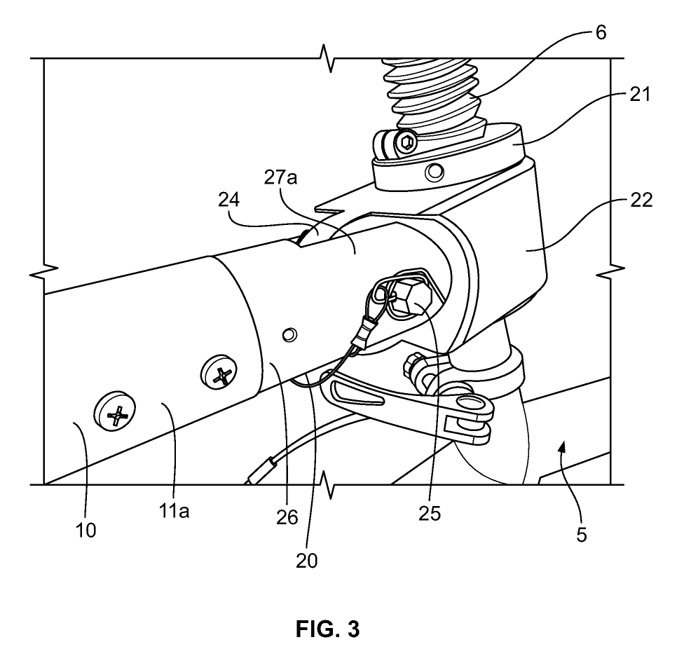

Coupling assembly 20 is best shown in FIG. 3. As depicted, the coupling assembly includes a sleeve 21, a first portion 22 and a second portion 26. An end of the coupling assembly closest to a vehicle when connected to the vehicle is also referred to herein as a front end while an opposite end closest to the longitudinal member when connected to the trailer is also referred to herein as a rear end. First portion 22 includes an opening therethrough sized for placement of sleeve 21 inside. First portion 22 is configured to be connectable to vehicle 5 via sleeve 21, as shown in FIG. 3, and second portion 26 is configured to be connectable to longitudinal member 10. Sleeve 21 includes a passage 23 therethrough as shown in FIGS. 4A and 4B, and, as will be described in greater detail below, a first axis of rotation Z-Z passes through a centerline of passage 23. Sleeve 21 is preferably made of aluminum material. Passage 23 is sized so that sleeve 21, and in turn first portion 22, can be positioned over seat post 6 of vehicle 5, as shown in FIG. 3. To support sleeve 21 disposed in first portion 22, first portion 22 includes a cutout 22a for a retaining ring (not shown). Also around first portion 22 is washer 22b secured at a bottom side of first portion 22, as shown in FIG. 4B. The retaining ring and washer 22b are configured to maintain the first portion in place relative to sleeve 21, which will be directly secured to seat post 6.

When assembled and secured to vehicle 5, first portion 22 rotates relative to the Z-Z axis, and the Z-Z axis is approximately perpendicular to a ground surface below the vehicle. As described herein, approximately perpendicular to the ground means between about 60 degrees and 110 degrees when measured from the ground upward while facing a rear end of the vehicle. Thus, when the vehicle is a bicycle and a seat post of the bicycle extends in a rearward direction toward its upper end, the angle between that post and the ground can be as low as 60 degrees. More preferably, the angle between the Z-Z axis and the ground is between 70 and 80 degrees. Most preferably, when the vehicle is a bicycle, the angle between the Z-Z axis and the ground may be a specific angle between 70 and 80 degrees that is a function of user specific considerations, such as the bicycle size and whether it is a mountain bicycle or touring bicycle, for example. Other angles may be preferred within the above ranges when the vehicle is not a bicycle.

Remote from passage 23 is an interconnection end 24 which acts as a bushing for second portion 26. Interconnection end 24 is best shown in FIGS. 3 and 4A. A roll pin 25 is positioned through interconnection end 24 and second portion 26 to secure first and second portions 22, 26 together. A second axis of rotation is represented by axis Y-Y, which passes through roll pin 25 and is approximately perpendicular to the Z-Z axis. Axis Y-Y represents the axis about which first and second portions rotate with respect to one another. Approximately perpendicular as used with reference to an angle between the Y-Y and Z-Z axes means an angle between about 85 and 95 degrees, though the angle is preferably between about 89 and 91 degrees and is most preferably close to 90 degrees. First portion 22 as depicted is made of delrin material though other materials may be used and are contemplated.

Second portion 26 includes a first end 27 shaped to fit around interconnection end 24 of first portion 22 as best shown in FIG. 3. In this manner, first end has a pair of arms 27a, 27b such that first end is fork shaped in appearance and it extends around interconnection end 24 of first portion 22. In addition, first end includes passages through both arms 27a, 27b (FIG. 4A). Thus, when first and second portions 22, 26 are connected to one another via roll pin 25, the roll pin extends through arm 27a, interconnection end 24, and arm 27b. This structure allows second portion 26 to rotate relative to first portion 22 about axis Y-Y through roll pin 25. Second portion 26 is preferably made of anodized aluminum. Toward a second end 28 of second portion 26 and disposed within second portion 26 is roll pin 29. Second portion 26 further accommodates pin 12 which is held in place within second portion 26 by roll pin 29, as best shown in FIGS. 4A and 4B. Pin 12 is sized so that when fully disposed within second portion 26 it extends outside of the coupling assembly toward longitudinal member 10. To optimize performance, pin 12 is tightly fitted to second portion 26 when the trailer is assembled.

Pin 12 bridges together longitudinal member 10 and coupling assembly 20. In the depicted embodiment, a cotter pin 14 is disposed at one end of pin 12 to hold pin 12 in place within hollow area 17 of longitudinal member 10 while another end of pin 12 is held in place within coupling assembly 20 by pin 29. Cotter pin 14 is configured so that when pin 12 is secured within longitudinal member 10 and tension pulls coupling assembly 20 from longitudinal member 10, cotter pin 14 holds pin 12 in place. Cotter pin 14 and its interface with pin 12 and solid structure 15 is configured so that while pin 12 remains rotationally fixed relative to coupling assembly 20, solid structure 15 and longitudinal member 10 may together rotate relative to coupling assembly 20 about an axis through pin 12, defined herein as axis X-X. Axis X-X is approximately perpendicular to both axis Y-Y and Z-Z. Approximately perpendicular as used with reference to an angle between the X-X and Y-Y axes or between the X-X and Z-Z axes means an angle between about 85 and 95 degrees, though the angle is preferably between about 89 and 91 degrees and is most preferably close to 90 degrees. The locations of axes X-X, Y-Y and Z-Z as described are preferably such that when assembled as part of trailer 1, axis X-X passes through both axis Y-Y and Z-Z. The pins and other similar interconnection elements as described are made of stainless steel, though other materials as known in the art are also contemplated.

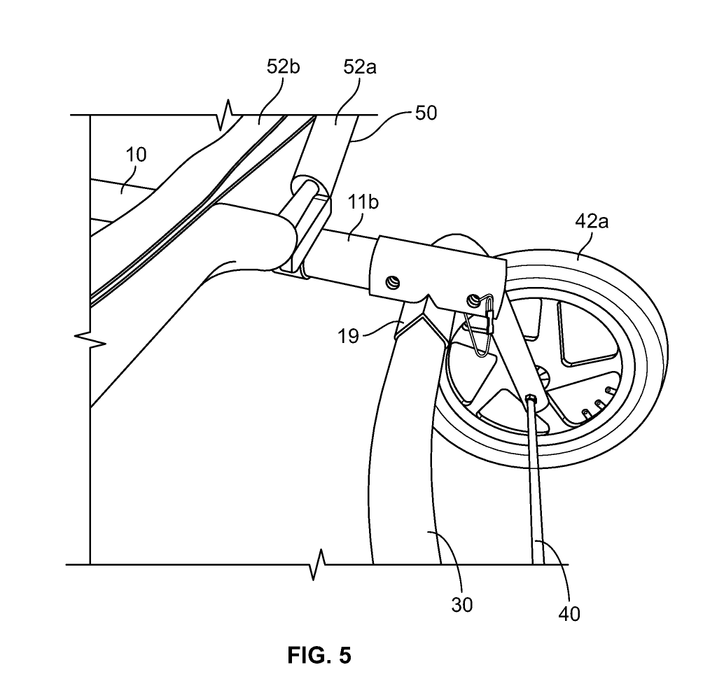

At second end 11b of longitudinal member 10 is U-shaped bar 30, also referred to as an extension member or yoke, connecting longitudinal member 10 to wheels 42a, 42b of the trailer. As shown in FIG. 5, longitudinal member 10 is welded 19 to U-shaped bar 30. Although a weld is depicted, other forms of securement between longitudinal member 10 and U-shaped bar 30 are contemplated provided that such connection is fixed in nature. For example, longitudinal support member 10 can be bolted to U-shaped bar 30 with multiple bolts. U-shaped bar 30 is preferably made of anodized aluminum. Ends of U-shaped bar 30 are fixedly secured to an axle 40, with wheels 42a, 42b secured at ends of axle 40.

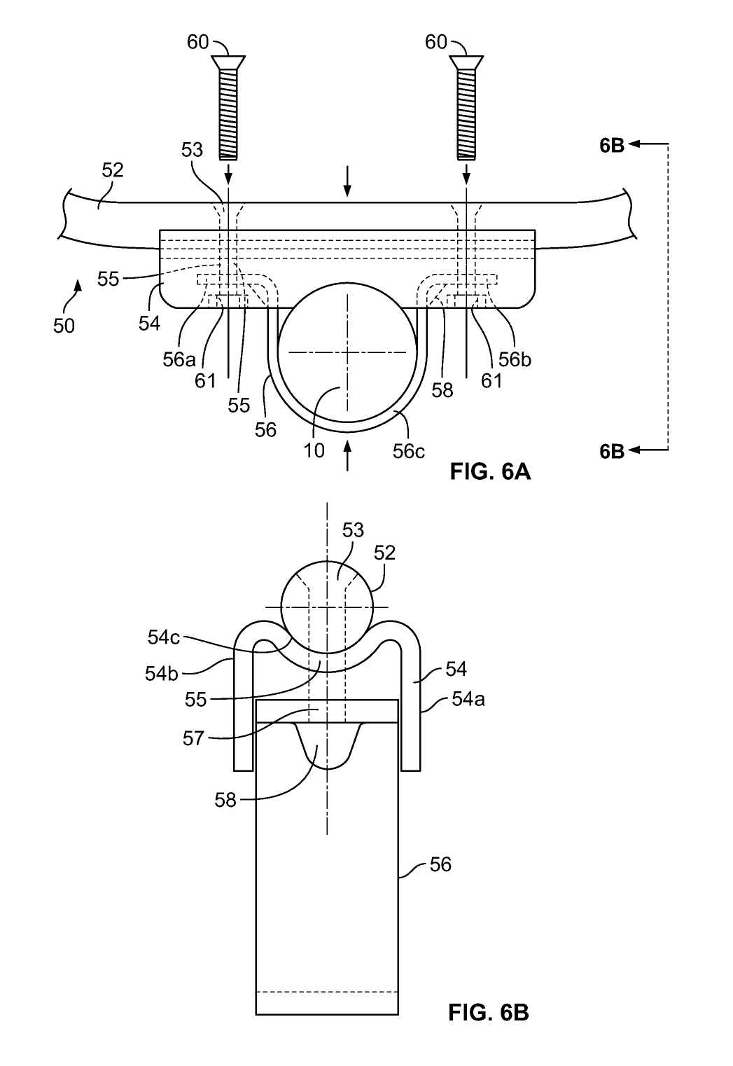

Secured at different locations on longitudinal member 10 are storage support members 50. Trailer 1 of FIGS. 1 and 2 includes three such storage support members 50. Each storage support member 50 includes several components, as best shown in FIGS. 6A and 6B. In particular, the principal structural components for storage support member 50 include lateral bar 52, clamp, and a securement mechanism between the two, details of which are described as follows. Lateral bar 52 is a load bearing component extending laterally from longitudinal member 10 when secured to trailer 1. Lateral bar 52 includes bent portions on its length so that equipment stored on the trailer will not be in direct contact with the connection point between storage support member 50 and longitudinal member 10. Such bent portions are shown in FIG. 2, though it is contemplated that the angulation of the lateral bars may vary in many ways as a matter of design choice. As depicted, an outer diameter of lateral bar 52 is 0.625 inches (15.88 mm), though the outer diameter may vary depending on the load to be carried by trailer 1.

Another component of each storage support member 50 is the clamp which includes a dual flange support 54 and a lower support 56. The clamp is configured to connect and secure lateral bar 52 with longitudinal member 10, as shown, for example, in FIG. 6A. Dual flange support 54 of the clamp includes an E-shaped cross-section so that lateral bar 52 can fit within a concave seat 54c in between the outer flanges 54a, 54b (FIG. 6B). An additional purpose of concave seat 54C (or notch) of dual flange support 54 is to provide added stiffness when clamping. Dual flange support 54 includes a length sufficient so that its structural integrity is maintained when loads bear on lateral bar 52 and so that there is sufficient space on both sides of longitudinal member 10 to place bolts or other fasteners through dual flange support 54 on each side of longitudinal member 10 as shown in FIG. 6A. Further, a structure of dual flange support 54 will have sufficient thickness and length to minimize any potential for buckling or other adverse impacts on its structure when it is placed under load, such as when bolts (e.g., 60) are used to secure dual flange support 54 to lower support 56 or when equipment is placed onto lateral support bar 52 over dual flange support 54. This also prevents crushing of longitudinal support member 10, which might otherwise be a risk, such as with the use of a U-bolt to secure lateral bar 52 to longitudinal member 10.

Lower support 56 includes a cross-section that is U-shaped with flanges 56a, 56b extending outwardly from ends of the U, as shown in FIG. 6A. Underneath the flanges of lower support 56 at the ends of the U-shape, gusset plates 58 are welded into place, or a simple weld is made, to provide additional integrity to lower support 56 which is particularly advantageous when storage support member 50 is subject to loads. A cross-section of lower support 56 is sized to accommodate disposal of longitudinal member 10 therein. In particular, a concave seat 56c of the U-shaped portion of lower support 56 corresponds to a perimeter of longitudinal support member 10. Lower support 56 has a length so that flanges 54a, 54b of dual flange support 54 can be placed around lower support 56, as shown in FIG. 6B. The lateral bar, dual flange support and lower support are preferably made of aluminum material, though other materials may be used as a matter of design choice.

In its assembled state when secured to longitudinal member 10, lateral bar 52 of storage support member 50 is oriented approximately perpendicular to longitudinal member 10 and rests within concave seat 54c of dual flange support 54. In this manner, the length of dual flange support 54 is parallel to a length of lateral bar 52. Lower support 56 is positioned so that dual flange support 54 is located between lateral bar 52 and lower support 56, and so that the U-shaped portion of lower support 56 wraps around one side of longitudinal member 10. When all three components are properly positioned, openings 53, 55, 57 (FIGS. 6A, 6B) are aligned for placement of a bolt or other fastener therethrough. Such openings 53, 55, 57 are located on both sides of longitudinal member 10 when measured in a direction of the length of lateral bar 52. Thus, securement of such fasteners to storage support member 50 provides fixation of member 50 with longitudinal member 10. In the depicted embodiment, lateral bar 52 is welded to dual flange support 54. Through welding, shear in lateral bar 52 is minimized when bolts are in place through the support and when load is applied to the assembled structure. Of course, the welding is done in a manner so that bolt holes 53 align with bolt holes 55. Alternatively, it is contemplated that other forms of fixed securement may be used to secure lateral bar 52 to dual flange support 54.

Through this novel structure, storage support member 50 may be secured to longitudinal support member 10 at any angle relative to the ground below trailer 1. The design also allows for the addition and removal of storage support members independent of an initial storage support member or members because the storage support member does not have to be slid off the longitudinal support member to be removed or installed. Rather, each storage support member 50 can be installed or removed at a desired placement location. With regard to position relative to the trailer frame, storage support members can be positioned at various orientations relative to the ground along different points on the length of the longitudinal support member when secured to longitudinal support member. Further, the installation, removal and movement of storage support members 50 is simple and easy to perform and allows a user to tailor the configuration of the support structure to support a variety of equipment shapes, sizes and weights loaded onto the trailer. It is also simple and easy to clean.

As depicted in FIGS. 1, 2 and 5, storage support member 50 further includes foam covers 52a placed over lateral bar 52 and a flexible strap 52b secured to lateral bar. Foam cover 52a mitigates scratching of equipment stored on the trailer and provides a surface that generates friction when contacted with other objects to prevent unwanted movement. Flexible strap 52b can be used to tie down equipment as would be appreciated by one of ordinary skill in the art. These features may be substituted with others or in some variants not included at all.

The structure of the trailer can be varied in many ways. For example, longitudinal support member can include two or more components where at least two such components have different diameters. The components may be assembled in such a manner that each forms a portion of the longitudinal support member length, and so that the components can be adjustable relative to one another. This is otherwise described as a telescoping feature. In this manner, the longitudinal support member may have an adjustable length to accommodate different types of equipment. Connection between each telescoping element may be with fasteners such as bolts, or other connective elements as known in the art. In use, smaller diameter components may be positioned inside larger components to improve securement and to allow adjustment through linear movement of one component with respect to another. For the trailer of this example, the storage support members may include components of different sizes, at least one size for each diameter of the telescoping longitudinal support member. In this manner, where a first longitudinal support member is a first size, a corresponding lower support size is used. Similarly, where a second longitudinal support member is a second size, a corresponding lower support size is used. In still further examples, a cross-section of longitudinal support member and corresponding coupling assembly second portion may be ovular, oblong, or polygonal. In such configurations, the lower support of storage support member is shaped to correspond with longitudinal support member.

In another example, the coupling assembly can include pins, bolts and screws other than those shown in the depicted embodiment. The geometry of the first and second portions of the coupling assembly facing each other need not be limited to that depicted in FIGS. 3, 4A and 4B. Rather, first and second portions may be shaped in any number of ways so long as the requisite function is provided and a member can interconnect both and provide an axis about which the second portion can pivot relative to the first. In other examples, first portion and sleeve may be a monolithic structure so that no separate sleeve structure is used to connect to a vehicle frame member. Further, in the above embodiment and in others, securement means other than set screws can be used to secure coupling assembly to a frame member of a vehicle. One of ordinary skill in the art will appreciate that a fixation location on pin 12 could also be within longitudinal member 10 rather than within coupling assembly 20 through application of the same principles. In still further examples, the coupling assembly may include a structure designed to accommodate other relative locations on the assembly for the rotation about each axis (i.e., locations for the X-X, Y-Y and Z-Z axes). In one example of this, a location of rotation about the X-X axis on the coupling assembly is closest to the vehicle connection, while a location of rotation about the Z-Z axis is in the middle of the coupling assembly and a location of rotation about the Y-Y axis is closest to the longitudinal member connection. In this manner, it is contemplated that the coupling assembly may be constructed so that any conceivable arrangement or order of locations for each of the axes of rotation may be provided on or in the structure of the coupling assembly.

In other examples, components of the storage support member may include four openings each so that four bolts or other fasteners may be used to secure the components together over the longitudinal support member. Similarly, it is envisioned that further variants are possible where dual support flange and lower support are of correspondingly sufficient size. For example, six or eight openings may be included when dual flange support is of sufficient length.

In other examples, the extension member connecting the longitudinal support member with the wheels can be of a V-shaped construction or any other shape capable of transferring load from the longitudinal support member to the wheels. In further examples, three or more wheels may be included with the trailer. It is also possible to include two axles each with a wheel secured at each axle end, though any combination or configuration of axes and wheels are contemplated. For example, a single axle can include two wheels at each end.

In other examples, the vehicle used to pull the trailer can be an automobile or any vehicle including or adapted to include a vertically extending frame member at or near its rear so that coupling assembly can be disposed and secured thereon. However, it is envisioned that the trailer as described herein will primarily be used in conjunction with a bicycle and other vehicles having two wheels.

In variants of the above embodiments and examples, the trailer may also include additional storage elements secured to longitudinal support member such as cargo holders secured in a position directly below longitudinal support member. Non-limiting examples include fiberglass coolers, racks and frames adapted to hold fishing rods. Such elements can be secured to longitudinal support member through techniques as known to those of ordinary skill in the art, such as through clips, screws or even welding, if desired.

In any of the above embodiments, materials of each component of the trailer may vary to suit load bearing, environmental or other conditions that are expected with use of the trailer. For example, the longitudinal member or various components of the coupling assembly may be made of materials other than aluminum to suit particular uses that do not benefit most from a lightweight trailer structure.

Another aspect of the invention involves assembly of trailer 1. In one embodiment, U-shaped bar 30 is secured to axle 40 supporting wheels 42a, 42b so that U-shaped bar 30 is fixed relative to axle 40. Longitudinal member 10 is then fixed onto U-shaped bar 30. As depicted, welding is used to form the fixed connection. Intermediate element 19, shown in FIG. 5, is positioned over second end 11b of longitudinal member to simplify the weld required to create a secure connection between longitudinal support member 10 and U-shaped bar 30.

At first end 11a of longitudinal member 10, coupling assembly 20 is secured to longitudinal member 10. In one approach, pin 12 with cotter pin 14 at its end is slid into hollow area 17 of longitudinal member 10 and then solid structure 15 is passed over pin 12 into longitudinal member 10. Alternatively, pin 12 and solid structure 15 are placed together into hollow area 17. Solid structure 15 is then secured in place with bolts 16, which are placed through the circumferential structure of longitudinal support member 10. With solid structure 15 secured, pin 12 remains in place held by cotter pin 14. Coupling assembly 20 components as described directly above are shown in isolation in FIG. 4C. Coupling assembly 20 is then slid over pin 12 and roll pin 29 is used to secure coupling assembly 20 to pin 12. In a variant, pin 12, with sold structure 15 disposed thereon, is secured to second portion 26 of coupling assembly via pin 29 prior to insertion into hollow area 17. Coupling assembly 20, with each component connected to one another, is shown connected to longitudinal support member 10 in FIGS. 4A and 4B.

With coupling assembly 20 attached to longitudinal support member 10, assembly of storage support members 50 is performed. First, lower support 56 is positioned against longitudinal support member 10 at a location and in an orientation desired by a user. One example of this is illustrated in FIGS. 6A and 6B. Then, lateral bar 52 with dual flange support 54 is positioned opposite lower support 56 on the other side of longitudinal support member so that openings 53, 55, 57 are aligned. A bolt or other fastener (e.g., 60) is then placed through the openings on each side of longitudinal support member to fasten storage support member 50 to longitudinal support member 10 (FIG. 6A). In one variant, the fastening step is completed with the securement of a hex nut 61 to fastener 60 underneath lower support 56. This process is repeated for each storage support member 50 intended to be affixed to longitudinal support member 10. Of course, in yet another alternative, the storage support members may be secured to the longitudinal support member before securing the coupling assembly to the longitudinal support member.

Once these steps are complete, trailer 1 is ready for engagement with a vehicle. The nature and arrangement of each component of trailer 1 provides a structure that is simple to assemble and disassemble for purposes of cleaning, storage and/or transport. In variants of the above, the method of assembly can be adapted and otherwise modified for any embodiment of the trailer structure contemplated herein.

Another aspect the present invention relates to a method of using trailer 1. In one embodiment, the structure of trailer 1 is configured to support a variety of equipment, such as surfboards and stand up paddle boards. Equipment (not shown) is loaded onto trailer 1 by placing it over and then onto lateral bars 52. For example, where there are three lateral bars 52 as shown in FIG. 2, the equipment will be placed over a combination of all three to uniformly and otherwise optimally distribute the weight of the equipment. To secure the equipment in place, straps 52b are used (FIG. 2). Of course, structures for securement are not limited to straps and other forms of securement are also contemplated. In this manner, the method of securing the equipment onto lateral bars 52 of storage support member 50 can be any known to those of ordinary skill in the art. Trailer 1, when assembled with three storage support members 50 placed thereon, is designed to accommodate at least 200 pounds of load when such load is placed uniformly over all three storage support members 50. Each individual storage support member 50 as depicted in FIGS. 1 and 2 is designed to support up to 50 pounds of load when such load is borne solely by the single storage support member.

Next, the trailer is secured to vehicle 5 (see FIGS. 1-3). Although the vehicle for the method as described is a bicycle, other vehicles are also contemplated, as described above. To secure trailer 1, first portion 22 of coupling assembly with sleeve 21 disposed therein is lifted over seat post 6 of vehicle 5. Passage 23 within sleeve 21 is positioned over seat post 6 and slid over it. Because sleeve 21 includes set screws 21a, coupling assembly 20 can be secured to a range of post 6 sizes by adjusting the position of set screws 21a. Once sleeve 21 is placed over seat post 6 and advanced to a desired position, set screws 21a are adjusted to secure coupling assembly 20 to vehicle 5. Although set screws 21a are shown, other mechanisms as known in the art may also be used to secure sleeve 21 to vehicle 5. With the trailer secured to the vehicle, the wheels of the trailer remain oriented approximately perpendicular to the ground below the trailer even if the wheels of the vehicle are oriented at an acute angle relative to the ground. This condition is maintained no matter the orientation of the vehicle as the coupling assembly 20 will rotate about its longitudinal axis i.e., X-X axis, when the vehicle is tilted toward the ground, while the longitudinal support member will not undergo a corresponding rotation. In this manner, an angle between a wheel of the vehicle and a ground surface below the vehicle varies independently from an angle between the wheels of the trailer and the ground surface. As described above, this structural function is exhibited because coupling assembly 20 is rotatable relative to longitudinal support member 10 about the X-X axis. With the trailer secured in place, the vehicle may be used to pull the trailer.

The structure of trailer 1 ensures that both trailer 1 and any equipment (not shown) stored thereon remain stable while the trailer is pulled. Thus, as the vehicle propels forward in a straight direction such that the wheels of the vehicle pass through a plane approximately ninety degrees relative to a ground surface below the wheels of the vehicle, wheels 42a, 42b of trailer 1 remain at the same or nearly the same angle relative to the ground as the wheels of the vehicle. When vehicle 5 is tilted either to the left or to the right, such as when the operator of the vehicle executes a turning movement, the plane passing through the wheel or wheels of the vehicle is oriented at an angle closer to the ground than when the vehicle travels in a straight direction. For example, the plane through the vehicle wheels can be sixty degrees relative to the ground. As mentioned briefly above, in such circumstances, coupling assembly 20 rotates about the X-X axis relative to longitudinal support member 10 so that the longitudinal support member and U-shaped member 30 with wheels 42a, 42b secured thereto do not rotate with the vehicle. This provides enhanced stability to both the wheels of the trailer and the equipment stored thereon, as the risk of the equipment sliding or falling off the trailer is greatly reduced if not entirely eliminated.

Trailer 1 is also designed to maintain stability when a slope of the ground surface below the vehicle varies from a slope below trailer 1. For example, when a slope of the ground below the rear wheel of the vehicle in a direction perpendicular to the wheel is different from a slope of the ground below the wheels of the trailer in a direction perpendicular to the wheels, a corresponding rotation about the X-X axis between coupling assembly 20 and longitudinal support member 10 takes place so that all wheels of both the vehicle and trailer remain in contact with the ground.

Because coupling assembly 20 is configured so that trailer 1 has three axes of movement relative to the vehicle, i.e., about axes X-X, Y-Y and Z-Z, the direction the trailer faces may not always be the same as that of the vehicle. In particular, coupling assembly rotates about axis Z-Z as the vehicle turns, causing turning movements of the trailer to lag those of the vehicle. Similarly, if the terrain traversed by the vehicle pulling the trailer is hilly, for example, second portion 26 of coupling assembly 20 may also pivot about axis Y-Y relative to first portion 22 in the event that the elevation below the vehicle and the elevation below the axle of the trailer varies. No axis of rotation limits movement in another. In this manner, rotation may occur in any one, two or three of axes X-X, Y-Y or Z-Z as the trailer is pulled by the vehicle. Rotation about each axis is independent of the others. Thus, where rotation occurs about two or more of the axes, an amount about one axis is independent of the others and can be any amount supported by the physical construction of the trailer and the available physical space surrounding it. In practical operation, the rotation necessary for normal use of a vehicle will not cause contact between the trailer and the vehicle. Accordingly, the trailer is adapted for a wide range of movements during use while preserving the integrity of the trailer and its contents, such as equipment stored thereon.

When transport is complete and the user is ready to remove trailer 1 from vehicle 5, vehicle seat is removed, set screws 21a are loosened, and then trailer 1, including all components of coupling assembly 20, is removed from vehicle 5. Alternatively, particularly if the trailer is intended to be reattached in the near future, pin 25 can be removed from coupling assembly 20 to detach only second portion 26 of coupling assembly 20 and the other components of trailer 1 from vehicle 5, leaving first portion 22 secured to seat 6. Trailer 1 is then set on the ground or another stable surface and equipment can be removed following loosening of straps 52a or other applicable securement features. As noted above for placement of the equipment, the equipment may also be removed from trailer 1 prior to removing trailer 1 from vehicle 5. While the trailer is detached from the vehicle, additional stability is provided by having at least two wheels (e.g., 42a, 42b) secured at the rear of the trailer. With two wheels, the risk of rollover at the wheel location is minimized under changing load conditions and movement because each wheel is opposite the other from a centerline of the trailer. Further, the trailer is stable because load distribution is through fixed structures that do not rotate with respect to one another. For example, loads bearing on longitudinal member 10 are at least partially distributed through U-shaped member to the wheels without causing any portion of trailer to rotate or otherwise become unstable. Put another way, further stability is provided through the fact that the structure permitting rotation about the X-X axis is not located between the wheels and the equipment. Rather, the distance between these locations is rigid. Thus, the equipment will not rotate relative to the wheel base while the trailer is in a rested position on the ground.

Another advantage of the trailer when carrying equipment is the enhanced safety it provides when the equipment stored has a high center of gravity. Described as an example, in the event the center of gravity of equipment stored on the trailer is so high that the trailer tips over, the location of coupling assembly 20 controlling rotation about the X-X axis between the location of the equipment and the vehicle allows the equipment to tip over while the longitudinal support member rotates, but the vehicle may remain stationary or turn over much less since the longitudinal member can rotate freely relative to the vehicle. This can minimize any injury to the operator of the vehicle that would otherwise result from the equipment tipping over.

Other advantages include that the longitudinal support member, and any equipment placed thereon, tracks with the wheels of the trailer so that the equipment on the trailer remains secure and stable no matter the position of the vehicle pulling the trailer. The location of rotation about the X-X axis at the juncture between first and second portions of coupling assembly provides this advantage, which would not exist were the location of rotation toward a rear end of the trailer proximal to U-shaped member. In the latter configuration, the equipment would be prone to tipping over when the operator of the vehicle leans into turns while travelling. It is also advantageous that three axes of rotation exist at the coupling assembly, not just one, for the same reasons just described. Namely, the trailer will remain stable even when there is movement of the vehicle relative to the trailer in the Y-Y or Z-Z axis.

The method of using the trailer can be varied in many ways. For example, one of ordinary skill will appreciate that the methods as described can be implemented with vehicles other than bicycles, provided that such vehicles include a frame positioned on the vehicle so that the coupling assembly can be secured thereto. However, advantages of the described trailer are optimized with two-wheel vehicles such as bicycles for the reason that the performance of the trailer is not impeded when such vehicles tilt towards the ground while turning.

In other examples, the position and orientation of each storage support member may be adjusted prior to placing equipment on the trailer to customize the support locations for the weight and shape of the equipment to be transported. As part of this adjustment, storage support members may be added or removed to accommodate the equipment placed on the trailer. In other example applications, a total of one, three, or more support members may be secured to the longitudinal support member. In one particular application, two support members can be placed adjacent to one another on the longitudinal support member and oriented vertically. This may also be done with multiple pairs of storage support members. In this manner, two pieces of equipment can be stored on the trailer, one on each side of the storage support member pairs.

In other examples where the longitudinal support member includes a telescoping configuration, the method may involve adjusting the length of the longitudinal support member via its telescoping elements where the equipment is either longer or shorter than an existing length of the trailer. In still other examples, it is contemplated that the trailer can first be secured to the vehicle followed by placement of equipment onto the trailer.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A trailer comprising:
a longitudinal member having a first end and a second end;
wheels connected to the second end of the longitudinal member; and
a coupling assembly having a rear end and a forward end, the rear end connected to the first end of the longitudinal member and the forward end adapted to be connected to a vehicle, the coupling assembly configured so that when the coupling assembly is connected to a vehicle, the longitudinal member is rotatable relative to the vehicle about three separate axes.

2. The trailer of claim 1, wherein the coupling assembly further comprises:
a first portion that includes the forward end adapted to be connected to the vehicle, wherein the first portion is rotatable relative to the vehicle about a first axis when connected to the vehicle, and wherein the first axis is approximately perpendicular to a ground surface below the vehicle;
a second portion that includes the rear end connected to the longitudinal member and the first portion, wherein the second portion is rotatable relative to the first portion about a second axis;
wherein the longitudinal member is rotatable relative to the second portion of the coupling assembly about a third axis.

3. The trailer of claim 2, wherein the second axis is approximately perpendicular to the first axis.

4. The trailer of claim 3, wherein the third axis is approximately perpendicular to the first axis and the second axis.

5. The trailer of claim 4, wherein the third axis passes through the first axis, the second axis and a connection point between the first portion of the coupling assembly and a frame member of the vehicle.

6. The trailer of claim 2, wherein the second portion of the coupling assembly includes a first pin extending outward from a body of the second portion, the first pin adapted to extend into an opening in the longitudinal member and to maintain securement between the second portion and the longitudinal member.

7. The trailer of claim 6, further comprising a second pin connected to the first pin, the second pin abutting an interior structure within the longitudinal member such that the second pin prevents separation of the second portion of the coupling assembly from the longitudinal member when the coupling assembly and the longitudinal member are subject to forces directed away from an interface between the coupling assembly and the longitudinal member.

8. The trailer of claim 7, wherein the first portion includes an opening therethrough sized to fit over a frame member of the vehicle.

9. The trailer of claim 8, wherein the second portion includes an opening therethrough in communication with a second opening through the first portion when the second and first portion are connected to one another, the opening sized and positioned for the placement of a third pin therethrough, the third pin being positioned through the second axis of rotation.

10. The trailer of claim 1, further comprising an extension member connecting the longitudinal member to the wheels, the extension member being fixed to the longitudinal member at a proximal end and fixed to an axle of the wheels at a distal end.

11. The trailer of claim 1, wherein the longitudinal member is made of aluminum.

12. A trailer comprising:
a longitudinal member having a length extending between a first end and a second end;
wheels connected to the second end of the longitudinal member; and
a coupling assembly connected to the first end of the longitudinal member and adapted for connection to a vehicle, the coupling assembly configured so that when connected to the vehicle, an angle between a wheel of the vehicle defining a first plane and a ground surface below the vehicle defining a second plane varies independently from an angle between one of the wheels of the trailer defining a third plane and the second plane,
wherein the longitudinal member is made of metal material and is fixed about its longitudinal axis so that the first end, second end and locations in between do not rotate with respect to one another about a longitudinal axis of the longitudinal member, and
wherein the wheels of the trailer are connected to the longitudinal member such that the longitudinal member is rotationally fixed relative to an axle through the wheels of the trailer about a longitudinal axis of the longitudinal member.

13. The trailer of claim 12, wherein when the trailer is secured to the vehicle, the longitudinal member is adapted to move about three axes relative to a frame member of the vehicle without contacting the vehicle.

14. The trailer of claim 12, wherein the length of the longitudinal member is telescopically adjustable by advancing a first or second portion of the longitudinal member relative to a second portion of the longitudinal member.

15. The trailer of claim 12, further comprising a U-shaped extension member fixedly secured to the second end of the longitudinal member and fixedly secured to the axis through the wheels of the trailer so that the U-shaped extension member is positioned in between the longitudinal member and the axle for the wheels of the trailer.

16. A trailer comprising:
wheels;
a longitudinal member having a first end and a second end, the first end adapted to be connected to a vehicle and the second end connected to the wheels; and
a storage support member removably attachable to the longitudinal member;
wherein the storage support member is removably attachable at any position about an axis through a length of the longitudinal member, and
wherein the storage support member is removably attachable at any position along a length of the longitudinal member.

17. The trailer of claim 16, further comprising a second and a third storage support member such that a combination of the storage support member, the second storage support member and the third storage support member, when attached to the longitudinal member, is adapted to support up to 200 pounds of load when applied uniformly over the combination.

18. The trailer of claim 16, wherein the storage support member further comprises a clamp removably attached to the longitudinal member and a lateral bar, the clamp including a lower support sized to receive the longitudinal member therein and a dual flange support positionable around the lower support and over the longitudinal member, the dual flange support including openings for the placement of fasteners therethrough to secure the lateral bar to the clamp.

19. The trailer of claim 16, further comprising a second storage support member removably attached to the longitudinal member such that the second storage support member is attachable at a different position about the axis of the longitudinal member than the storage support member.

20. The trailer of claim 16, further comprising a second storage support member removably attached at any location on the longitudinal member from the first to second end.
